(19) United States
(12) Patent Application Publication
(10) Pub. No.: US 2016/0267593 A1
(43) Pub. Date: Sep. 15, 2016

(54) SYSTEMS AND METHODS FOR OBTAINING AND EXECUTING COMPUTER CODE SPECIFIED BY CODE ORDERS IN AN ELECTRONIC TRADING VENUE

(71) Applicant: Hayden Paul MELTON, Philadelphia, PA (US)

(72) Inventor: Hayden Paul MELTON, Philadelphia, PA (US)

(73) Assignee: THOMSON REUTERS (MARKETS) LLC, NEW YORK, NY (US)

(21) Appl. No.: 15/064,163

(22) Filed: Mar. 8, 2016

Related U.S. Application Data
(60) Provisional application No. 62/130,060, filed on Mar. 9, 2015.

(51) Int. Cl. G06Q 40/04

(52) U.S. Cl. CPC G06Q 40/04

(57) ABSTRACT

Disclosed is a system and method for processing code orders that specify orders to be processed on an electronic trading venue (ETV) based on computer code referenced by or included with the code orders. Market participants may define, associate and submit executable code with each order message they send to the ETV. Upon receipt of a code order, and before that message itself is processed by the ETV against the instrument's limit order book, the ETV may evaluate all of the code associated with active code orders in that limit order book and process any resulting orders. Responsive to the completion of this evaluation, the ETV may update the state of the limit order book to reflect the new prices and quantities of them. Responsive to the completion of the update, the ETV may process the new message, which triggered evaluation of the code orders against the limit order book.

### CROSS-REFERENCE TO RELATED APPLICATIONS

This application claims priority to U.S. Provisional Patent Application No. 62/130,060, filed Mar. 9, 2015, entitled “Order Type Containing Executable Code,” which is incorporated by reference in its entirety herein.

### FIELD OF THE INVENTION

The invention specifies systems and methods for processing code orders that specify orders to be processed on an electronic trading venue (ETV) based on computer code referenced by or included with the code orders.

### BACKGROUND OF THE INVENTION

Many electronic trading venues (ETVs) operate mechanisms that track a bid or offer state for the instruments that trade on them. A bid or offer state is indicative of bids and/or offers with respect to the instrument. One example is of a bid or offer state is the state of a central limit order book (CLOB), although other types of mechanisms may be used to track bid or offer states. Point-in-time “snapshots” of bid or offer states are distributed from the ETV to market participants as market data updates. Such updates may also include additional information that, depending on one's viewpoint may or may not be considered part of the bid or offer state, such as the price and quantity of the last trade that occurred on an instrument.

It is widely-accepted that information provided in market data updates can inform a participant's short-term trading decisions, e.g., whether to buy or sell an instrument, whether to cancel an existing bid or offer, whether to re-price an order, whether to lift or “take” a price by aggressing the market or to instead “make” a price by posting a standing order, and so on. Put another way, participants often react to changes in the bid or offer state as it appears to them in market data updates by submitting order-related messages to that ETV (e.g., new order requests, cancel-replace requests, cancel requests, etc.). In short, information contained within market data updates can cause order-related messages to be sent into an ETV.

Operators of ETVs typically want to encourage participants on their venues to submit “maker” orders (e.g., “bids” or “offers” that are inserted into a CLOB) when participants on those venues have an interest to buy or sell an instrument, rather than have those participants act mostly or even exclusively as “takers” of liquidity.

However, because of the constraints of networked technology, participants might prefer to use only “taker” orders (and not use “maker” orders at all) on a venue. For example, a market participant who, compared to other market participants, can react only relatively slowly by sending a cancel request in response to market data updates might have his maker orders (i.e., bids or offers) “picked off” or “sniped” by faster participants when the market is moving against the maker-participant. This problem can arise due to network latency or other network-based delays faced by the maker-participant when attempting to cancel or otherwise replace a maker order. In another example, submission of a competitively-priced maker order, which will almost certainly change the state of the CLOB in the next market data update, might in turn cause the market to move adversely against the maker-participant. Again, due to limitations in networked technologies that prevent the maker-participant from reacting quickly enough, the maker-participant may be at a disadvantage.

Operators of ETVs are therefore faced with the problem of incentivizing a market participant, who at any given instant in time has an interest to buy or sell, to submit a competitively-priced maker (bid or offer, respectively) instead of waiting until the state of the CLOB is such that the participant finds it desirable to send a “taker” order to buy or sell.

These and other drawbacks exist with conventional systems for processing electronic orders in an ETV.

### SUMMARY OF THE INVENTION

The invention addressing these and other drawbacks relates to systems and methods for processing code orders that specify orders to be processed on an ETV based on computer code referenced by or included with the code orders, according to an implementation of the invention.

Market participants on an ETV may create source code or computer code that defines a behavior of an order to be processed at the ETV. The order may relate to an instrument traded on the ETV. The source code or computer code may include a market participant's own re-pricing (or other order behavior adjustments) logic to be processed at the ETV. Market participants may then submit code orders, which include a reference to source code, a reference to computer code, source code (e.g., inline within a code order), and/or computer code.

If a reference to source code is included in a code order, the source code may be obtained based on a pre-stored association between the source code and the reference. In these implementations, the market participant may have generated source code templates, to be stored at the ETV and referenced later in code orders. In other instances, the source code itself (not a reference to the source code) may be provided by the market participant within a code order.

In either implementation, the ETV may compile (or interpret) the obtained source code to generate computer code. Such compiling may occur within the component that maintains the state of the instrument's central limit order book (“CLOB”). The term “CLOB” is used by example and not limitation. Other ways to maintain a bid or offer state may be used as well so as aggregate supply and demand, perform matching, organize orders, etc., on a given instrument or group of instruments. In some implementations, a reference to computer code or the computer code itself may be included in a code order.

A code order may be formatted according to various formats, such as a FIX message format. As such, a code order may be transmitted to the ETV as a message that includes the code order. Each time a new message is received by the ETV, the compiled code obtained based on each code order in the CLOB (received before the new message was received) is evaluated by the ETV, taking as input the state of the CLOB, and producing as output a new limit price or time-in-force for the order. As such, the ETV may prevent the new order from “sniping” any code orders in the CLOB that were received before the new order was received.

Because the foregoing process of input, evaluation and output associated with each code orders can occur within a (in some instances, single) component that is part of the ETV, the need for transmission of this input and output data over a network is eliminated, thereby achieving temporal fairness among active code orders in the CLOB, reducing network bandwidth requirements, and enhancing overall efficiency of ETV operation.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an exemplary system for processing code orders that specify orders to be processed on an ETV based on computer code referenced by or included with the code orders, according to an implementation of the invention.

FIG. 2 depicts an exemplary ETV that processes code orders, according to an implementation of the invention.

FIG. 3 depicts a process for processing code orders that specify orders to be processed on an ETV based on computer code referenced by or included with the code orders, according to an implementation of the invention.

FIG. 4 depicts a process for processing orders in an ETV that processes code orders and non-code orders, according to an implementation of the invention.

### DETAILED DESCRIPTION OF THE INVENTION

The invention described herein relates to a system and method for processing code orders that specify orders to be processed on an ETV based on computer code referenced by or included with the code orders, according to an implementation of the invention.

The term “market participant” (or simply “participant”) is intended to be broadly construed to refer to any entity that receives (through a computing device) market data from the venue, or sends (through a computing device) order-related messages to the venue, including, but not limited to: a firm that conducts business on the electronic trading venue, a credit entity associated with such a firm (a single firm may have a plurality of credit entities), or a user (human or otherwise). In the foregoing text, the user of the invention will select the specific form of participant to which methodology will apply.

Exemplary System Architecture

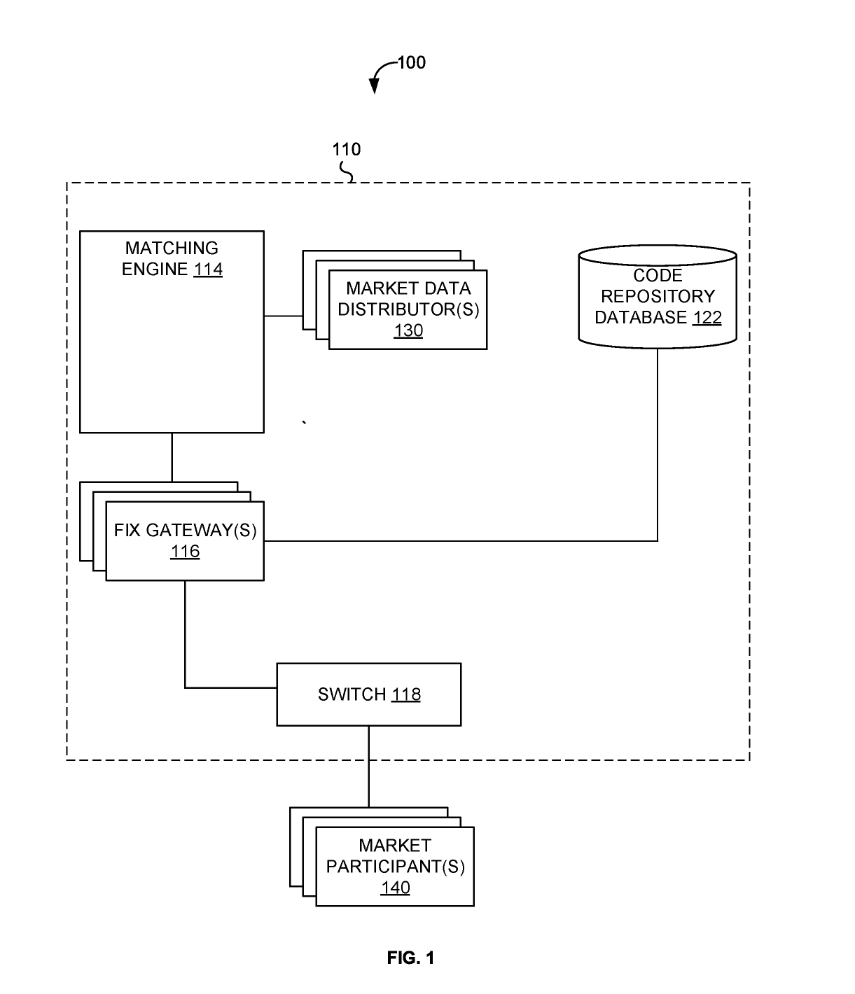

FIG. 1 illustrates an exemplary system 100 for processing code orders that specify orders to be processed on an ETV 110 based on computer code referenced by or included with the code orders, according to an implementation of the invention.

System 100 may include electronic trading venue 110 (used interchangeably with “venue 110” or “ETV 110” for convenience), one or more market data distributors 130, one or more market participants 140, and/or other components.

Venue 110 may include a matching engine 114, a FIX gateway 116, a switch 118, a code repository 122, a market data distributor 130, and/or other components. Market data distributor 130 may each receive information about matches and the Central Limit Order Books (CLOBs) and credit, and sends, to market participants 140, a credit-screened and unscreened view of the CLOB for the instruments that trade on venue 110.

FIX gateway 116 may each receive and send Financial Information eXchange (“FIX”) protocol messages such as new orders requests, execution reports, and so on. More than one of each of the above components of venue 110 (e.g., multiple market data distributors 130, multiple FIX gateways 116, etc.) may be used to achieve adequate performance (e.g., response times, throughput, etc.) through distributed (e.g., parallel) computing. FIX gateway 116 may receive and send other types of messages (other than FIX protocol messages) for new orders, execution reports, and so on, as well.

Market participants 140 (also referred to interchangeably as “participants 140” for convenience) are each entities that conduct business on venue 110 (represented in system 100 as devices used by such participants to interface with venue 110).

The various components illustrated in FIG. 1 may communicate with one another via one or more communication links (represented by lines between such components). The communication links may include network links through a network described herein. The various communication links are shown for illustration and not limitation, as one or more communication links between components not otherwise illustrated may be used as well.

In an exemplary operation, market participants 140 send in orders (including cancels, amendments, etc.) to venue 110 over the network, and receive market data updates from the venue over the network. In either case, the traffic maybe bi-directional (e.g., order-related traffic may be sent from venue 110 to participants 140 as execution reports for orders, and market data-related traffic maybe sent from participants 140 to venue 110 as subscription requests for specific instruments). Order-related network traffic is routed by switch 118, which may be implemented as a conventional network switch device, to one or more of the FIX gateway(s) 116. Market data-related network traffic may be provided by market data distributor 130 and is routed by switch 118 to participants 140.

A mapping from IP addresses to individual participant 140 (since a single participant may use a plurality of IP addresses to connect to venue 110), and mappings from IP addresses to specific components in venue 110 (e.g., to a certain FIX gateway 116 or market data distributor 130 may be written to a venue database (not illustrated).

In an implementation, ETV 110 (and other components of ETV 110) may be implemented in the JAVA programming language. Other programming languages may be used as well. The individual components of ETV 110 may be implemented as separate processes on separate hosts (computers) and communicate as indicated over a computer network using the TCP/IP protocol or other network protocol.

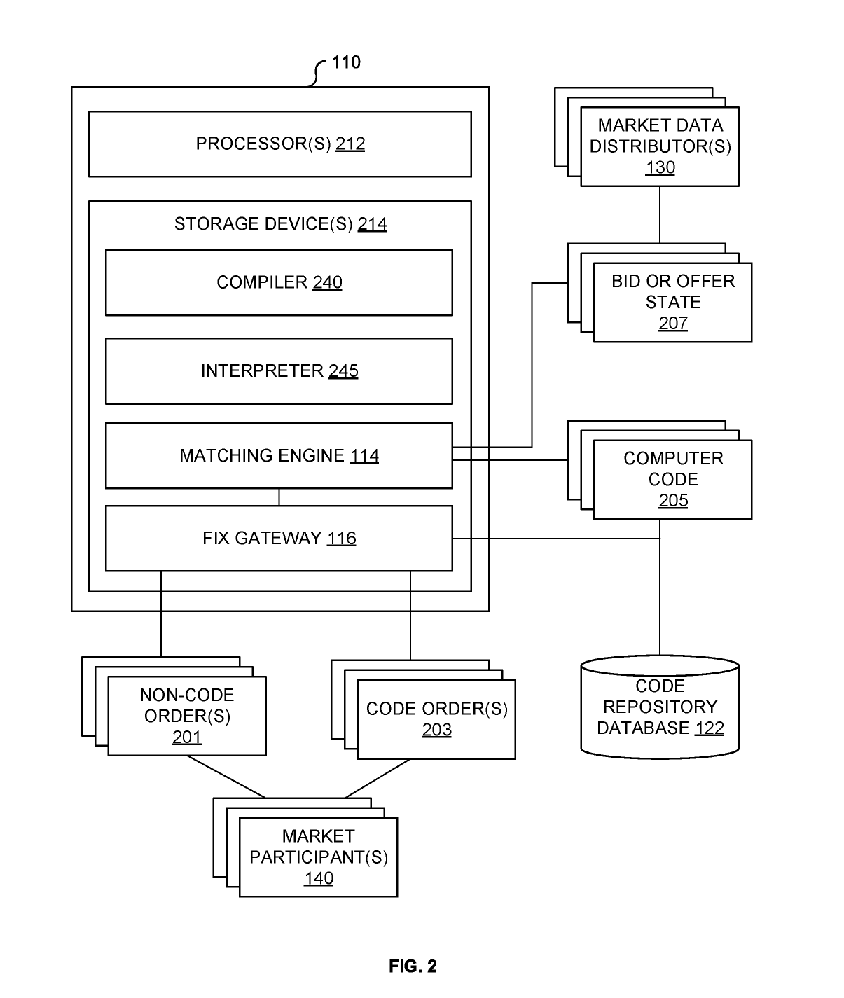

FIG. 2 depicts an exemplary ETV 110 that processes code orders, according to an implementation of the invention. ETV 110 may be configured as one or more servers (e.g., having one or more server blades, processors, etc.), one or more computers (e.g., a desktop computer, a laptop computer, etc.), and/or other device that is programmed to process code orders. In an implementation, ETV 110 may be configured as a cluster of commodity computing hardware programmed by various computer program instructions. For instance, the cluster may execute Apache™ Hadoop® software. In these implementations, code repository 122 (in reference to FIG. 1) may be implemented via the Hadoop Filesystem (HDFS) on this cluster and the instruction(s) that programs ETV 110 may be implemented to use the MapReduce API and HDFS-client API provided by Hadoop, and in the Java™ programming language.

Regardless of its particular implementation or configuration, ETV 110 may include one or more processors 212 (also interchangeably referred to herein as processors 212, processor(s) 212, or processor 212 for convenience), one or more storage devices 214 (which may store various instructions that program processors 212), and/or other components. Processors 212 may be programmed by one or more computer program instructions. The computer program instructions may include, without limitation, matching engine 114, fix gateway 116, compiler 240, interpreter 245, and/or other instructions that program ETV 110 to perform various operations, which are described in greater detail herein. As used herein, for convenience, the various instructions will be described as performing an operation, when, in fact, the various instructions program the processors 212 (and ETV 110) to perform the operation. Alternatively or additionally, any one of the foregoing components of ETV 110 stored at storage device 214 may include hardware, including specialized networking hardware configured to receive and process code orders.

Processing Non-Code Orders and Code Orders

In an implementation, ETV 110 may receive orders from market participants 140. The orders may be received through fix gateway(s) 116 (which may itself receive the order via switch 118, which is not illustrated in FIG. 2), or other source. A given order may be a non-code order 201 (e.g., not a code order, such as a conventional order) or a code order 203. A given order may be formatted as a message transmitted over a network. The message may include a FIX message having key-value pairs. Other types of messages may be used as well.

Fix gateway 116 may distinguish between different types of orders. For instance, a code order may include or otherwise be associated with information that indicates it is a code order. Such information may include, without limitation, header information, a new type of key-value pair within a FIX message, and/or other information that distinguishes code orders from non-code orders.

In an implementation, fix gateway 116 may determine whether the received order is a non-code order 201 or a code order 203. Such determination may be based on the presence or absence of information that indicates a code order. Alternatively or additionally, such determination may be based on the presence or absence of information that indicates a non-code order. For example and without limitation, fix gateway 116 may parse header information of the received order, parse a FIX message to determine whether a key-value pair that is reserved for code orders is present, and/or otherwise determine whether the received order is a non-code order or a code order.

Responsive to a determination that the received order is a non-code order 201, fix gateway 116 may provide the non-code order 201 to matching engine 230 for processing. On the other hand, responsive to a determination that the received order is a code order 203, fix gateway 116 may obtain computer code 205 based on the code order 203 and provide the computer code 205 to be executed (e.g., at matching engine 220).

Computer code 205 may include code that is executed by a computer. For example, the computer code 205 may include binary code (e.g., compiled by a compiler), interpreted code, and/or other types of code that programs, and is executed by, a computer. The computer code 205 may include logic that defines a behavior of an order. The behavior may include, for example, setting a trade parameter (e.g., bid price, offer price, quantity, etc.), canceling a trade, and/or other behaviors.

In some implementations, computer code 205 may adjust the behavior of the order based on inputs to the computer code 205. Behavior adjustments may include adjusting a trade parameter such as re-pricing a bid or offer price (which may have been specified by the market participant 140 as part of the code order 205), adjusting a quantity to be sold or purchased, changing an expiration condition, and/or other changes to a trade parameter. In some implementations, behavior adjustments may include canceling the trade specified by the code order 203.

The input may include a bid or offer state 207. For example, fix gateway 116 may obtain a bid or offer state 207 (e.g., a state of a CLOB) and provide the bid or offer state 207 as an input to computer code 205. Based on the input and logic of computer code 205, the behavior of an order specified by code order 203 (based on which computer code 205 was obtained) may be adjusted. For example, computer code 205 may include logic that specifies that an offer price is to be raised if a bid prices for the relevant instrument is increasing beyond the offer price. Computer code 205 may take as input a bid or offer state 207, determine that bid prices are increasing based on the bid or offer state 207, and automatically cause the offer price for the code order 203 to increase. As will be discussed below, computer code 205 may be executed prior to processing any newly received order (e.g., an order received at ETV 110 after code order 203 was received at ETV 110), thereby guaranteeing that the new order will not “snipe” the order specified by code order 203.

Obtaining Computer Code Based on Code Orders

In an implementation, fix gateway 116 may obtain computer code 205 based on code order 203 in various ways. For example, fix gateway 116 may obtain source code from a code order and then compile or interpret the source code to generate the computer code (whether as a binary file or in memory), obtain the computer code from the code order, obtain a reference to source code (which is then compiled or interpreted), or a reference to the computer code.

Obtaining Computer Code from Source Code Included with the Code Order

In an implementation, fix gateway 116 may obtain computer code 205 from code order 203 itself. In some implementations, for example, code order 203 may include source code that is to be compiled to generate computer code 205. In some of these implementations, code order 203 may indicate a computer language (e.g., JAVA, C, etc.) of the source code, a compiler to be used to compile the source code, and/or other information that specifies how the source code should be compiled. Otherwise, fix gateway 116 may use a default compiler.

Once fix gateway 116 determines that the code order 203 includes source code to be compiled, it may obtain the source code from code order 203. Fix gateway 116 may use an appropriate compiler 240 (whether specified by the code order 203 or a default compiler) to compile the source code to generate computer code 205. In an implementation, compiler 240 component may be a custom or non-standard JAVA or other language compiler. In some instances, only a subset of the JAVA or other language may supported (e.g., no loops, support for only certain data types, limits on the maximum size of code it can compile), to improve performance. A custom JAVA or other language compiler may be implemented and may impose restrictions on either the grammar that compiler accepts, or by walking the abstract syntax tree (AST) generated by that compiler, and rejecting ASTs that contain disallowed constructs, types, or operators, or that are too big in their number of statements.

In some implementations, code order 203 may include source code that is to be interpreted to generate computer code 205. In some of these implementations, code order 203 may indicate a computer language (e.g., PERL, PYTHON, etc.) of the source code to be interpreted, an interpreter to be used to interpret the source code, and/or other information that specifies how the source code should be interpreted. Otherwise, fix gateway 116 may use a default interpreter.

Once fix gateway 116 determines that the code order 203 includes source code to be interpreted, it may obtain the source code from code order 203. Fix gateway 116 may use an appropriate interpreter 245 (whether specified by the code order 203 or a default interpreter) to interpret the source code to generate computer code 205.

Obtaining Computer Code Based on a Reference Included with the Code Order

In an implementation, fix gateway 116 may obtain computer code 205 based on a reference (to source code or the computer code) included in the code order 203. For example, code order 203 may include a reference that is stored in association with either source code with which to generate computer code 205 and/or computer code 205 itself.

The reference may be stored in association with source code used to generate computer code 205 or computer code 205 itself based on a database link. Alternatively or additionally, the reference and the source code used to generate computer code 205 or computer code 205 itself may be stored as different columns within the same row of a database table entry. Other associations between the reference and source code or computer code 205 may be stored as well. For example, the reference may serve as a pointer to source code used to generate computer code 205 or computer code 205.

The reference may include identifying information such as, without limitation, a numeric identifier, an alphanumeric identifier, and/or other type of identifier. In some instances, a market participant 140 or others may assign a name to the reference.

In implementations in which code order 203 includes a reference to source code, fix gateway 116 may obtain the reference from code order 203 and obtain the source code based on the reference. For example, fix gateway 116 may perform a database lookup to obtain the source code based on the reference. Alternatively or additionally, fix gateway 116 may follow a pointer defined by the reference to obtain the source code. Fix gateway 116 may then compile the source using an appropriate compiler 245 (which may be identified as described above with respect to source code being included with the code order 203).

In implementations in which code order 203 includes a reference to computer code 205, fix gateway 116 may obtain the reference from code order 203 and obtain the computer code based on the reference. Fix gateway 116 may obtain the computer code 205 based on a database link, reference, and/or other association as described herein.

In some implementations, fix gateway 116 may determine whether the code order 203 includes a reference to source code, a reference to computer code, source code, or computer code 205 and obtain the computer code accordingly. In some implementations, the code order 203 may specify which of the foregoing have been used to identify the code order. In other implementations, fix gateway 116 may parse code order 203 to determine whether a reference or actual code is included with the code order. For instance, fix gateway 116 may parse certain key-value pairs (where a particular key-value pair corresponds to references to source code, another key-value pair corresponds to references to computer code, and so on) within the code order.

In some implementations, if a compile time or interpretation time error occurs (for implementations in which a code order 203 includes source code to be compiled or interpreted) or if a reference is not associated with any code (for implementations in which a code order 203 includes a reference), code order manager 205 may reject the code order 203. Code order manager 205 may cause an error message to be communicated back to market participant 140 (e.g., through fix gateway 116).

Executing the Computer Code to Process an Order

In some implementations, code order manager 205 (which may be executing at FIX gateway 116) may provide code order 203 (and/or computer code 205) to matching engine 230 for processing. Matching engine 230 may cause two orders to match if they are of opposite sides (buy and sell) and are price compatible. Other criteria may be used to match orders as well.

Code order manager 205 may create a new message for a code order 203 containing the fields on the FIX message required by the matching 230 engine and the computer code. The new message may be formatted as a GOOGLE Protocol Buffers format message. The new message may be generated by extracting, from a FIX message, the fields required by the matching engine 230 (in some implementations, discarding those that are not required by it), and by creating a binary or byte array field type in the Protocol Buffers message to contain the contents of the “.class” file or other code.

Code order manager 205 may transmit the message and/or the computer code to matching engine 230 for processing an order associated with the code order 203 (based on which the computer code was obtained). Upon receipt of the message, matching engine 230 may extract the computer code 205 from the new message. For example, if JAVA source code is compiled into bytecode, matching engine 230 may use a custom Java ClassLoader, whereby the name given to the extracted class can be used to unambiguously associate it with the specific code order to which it belongs. For example, the name of the Class extracted by the ClassLoader may be the integer ID of the code order 203. In this manner, matching engine 230 may associate computer code 205 with its corresponding code order 203.

If there are active code orders in the CLOB, the matching engine 230 may retain the computer code for those code orders in memory, and associate each such computer code with its code order, as described above. Upon the code order becoming inactive (because it was matched, canceled, expired, etc.) the matching engine 230 may remove the computer code from memory.

Upon receipt of a separate message (which relates to another order, which the other order is a code order or non-code order), matching engine 230 may, prior to processing the separate message against the CLOB, evaluate the computer code 205 of all active code orders 203 in that CLOB against a snapshot of the CLOB reflecting its current state. For various reasons the snapshot may only show the CLOB down to a certain depth on the bid and offer sides (e.g., only top 3 levels), and may aggregate orders at each price level to just expose their total quantity. The snapshot maybe represented in a Java class or other executable code portion, and may be immutable, and for performance reasons maybe “flyweight”.

Upon completion of the execution of all the computer code for each of the code orders, zero or more code orders with modified properties will exist. These will be matched and otherwise processed according to rules specified and disclosed by the market operator. The “old” versions of these orders will be removed from the CLOB, to be replaced by the “new” versions. Finally, the separate message that triggered the evaluation of the code orders will be processed against the CLOB. In this context “processed against the CLOB” is to be understood to mean inserted into the CLOB, removing an existing order from the CLOB, or matched with a contra order in the CLOB, and so on.

In an implementation, market participants may, via an interface (e.g., a web interface, a mobile application interface, and/or other interface), maintain their own template name to code mappings in the code repository 122. Such mappings maybe specified using XML or other format. A market participant's templates maybe private to them. In this implementation, the code repository 122 may implement security (login and password feature) such that a market participant 140 can access only his/her own templates. In this context a market participant 140 may be considered to be a firm, or an individual. It is to be appreciated that a market operator (e.g., an entity that operates ETV 110) may also implement their own disclosed algorithmic orders using code orders, and place these orders in the code repository 122 for read-only access by some or all market participants 140. Such template names may also include parameters e.g., one such order type might be named “PegOrder(int offset)”.

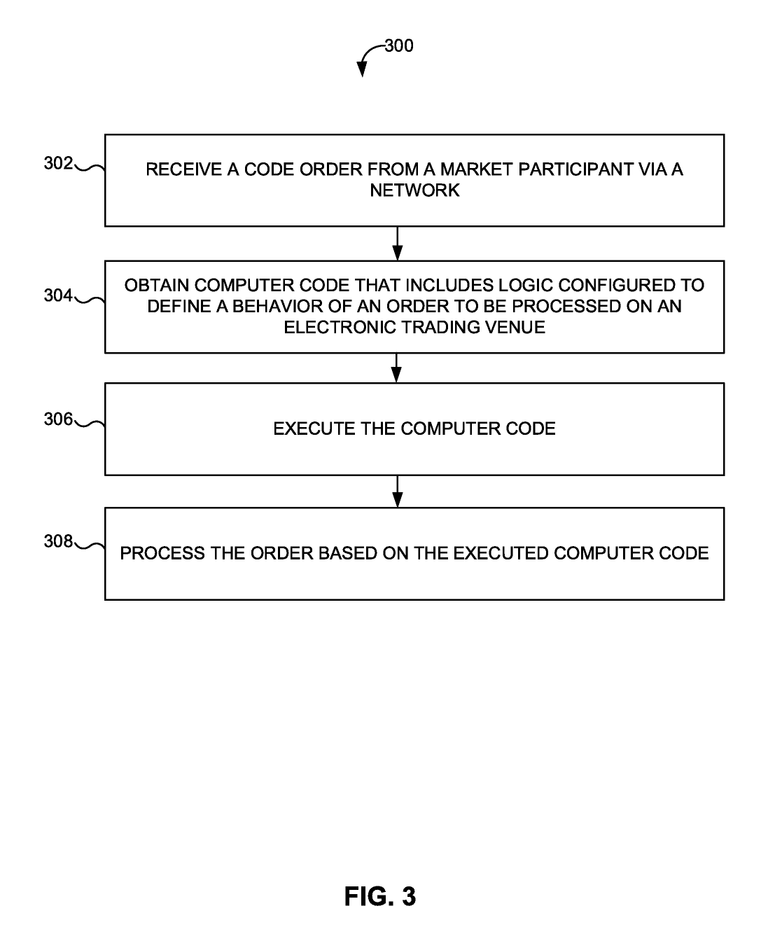

FIG. 3 depicts a process 300 for processing code orders that specify orders to be processed on an ETV based on computer code referenced by or included with the code orders, according to an implementation of the invention.

In an operation 302, process 300 may include receiving a code order from a market participant via a network. The code order may relate to an order to be placed in relation to an instrument traded on ETV 110. The code order may include a reference to source code, a reference to computer code, source code (e.g., inline within the code order), or computer code.

In an operation 304, process 300 may include obtaining, based on the code order, computer code that includes logic configured to define a behavior of an order to be processed on the ETV 110. For example, a reference included within the code order may be used to look up corresponding source code (which is then compiled or interpreted) or corresponding computer code. In another example, the code order may include the source code. In yet another example, the code order may include the computer code.

In an operation 306, process 300 may include executing, by the computer system, the computer code. For instance, matching engine 230 may execute the computer code.

In an operation 308, process 300 may include processing, by the computer system, the order based on executing the computer code. For example, the computer code may include logic that causes the order to be executed against a CLOB to which the instrument relates.

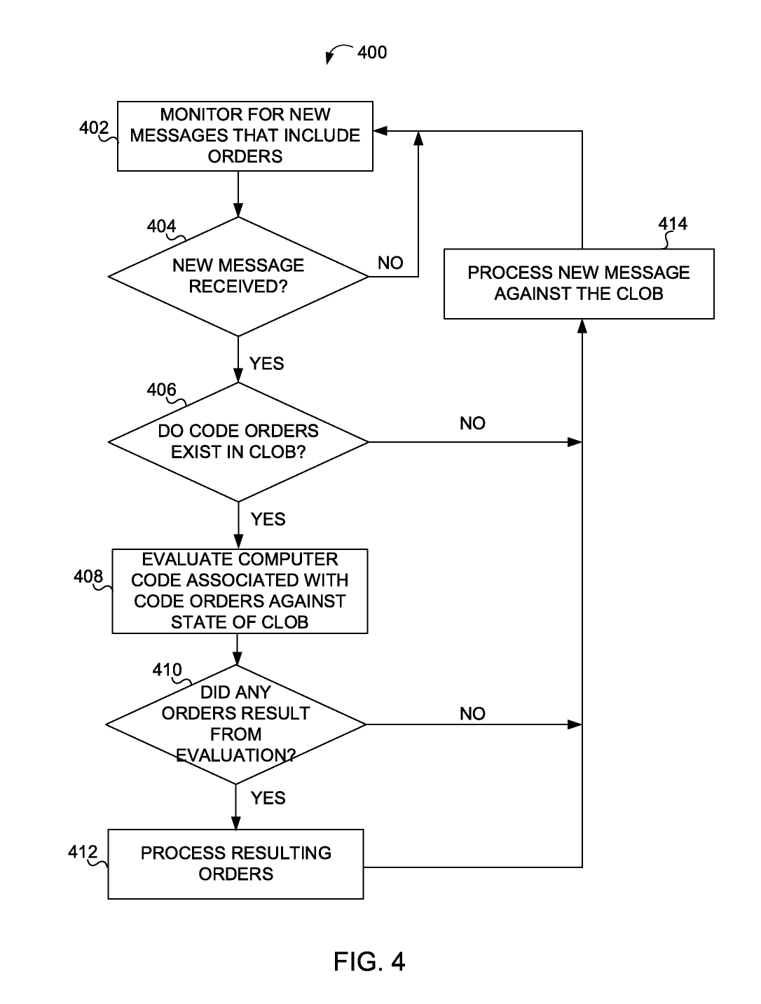

FIG. 4 depicts a process 400 for processing orders in an ETV 110 that processes code orders and non-code orders, according to an implementation of the invention.

In an operation 402, process 400 may include monitoring for new messages that include orders. For instance, fix gateway 116 may determine whether a new message comprising an order (whether a non-code order or a code order) has been received from a market participant 140 via a network.

In an operation 404, process 400 may include determining whether a new message has been received based on the monitoring. If no new message has been received, process 400 may continue monitoring for new messages.

In an operation 406, responsive to a determination that a new message has been received, process 400 may include determining whether any code orders exist in the CLOB (or other set of information or data structures that maintain a bid or offer state 207). If no code orders exist in the CLOB, then in an operation 414, process 400 may include processing the new message against the CLOB.

On the other hand, if code orders exist in the CLOB, then in an operation 408, process 400 may include evaluating the computer code associated with (e.g., obtained based on) code orders against the state of the CLOB.

In an operation 410, process 400 may include determining whether any new orders (e.g., trades to be executed) resulted from the evaluation. If no new orders resulted from the evaluation, process 400 may include processing the new message against the CLOB in an operation 414.

On the other hand, in an operation 412, responsive to a determination that new orders resulted from the evaluation, process 400 may include processing the resulting orders, after which process 400 may include processing the new message against the CLOB. In this manner, process 400 ensures that any code orders received and existing in the CLOB are processed before any new orders (e.g., any new messages containing new orders) are processed. As such, any new orders will not be able to “snipe” orders associated with the code orders.

In some implementations, if multiple orders exist in the CLOB or are otherwise received at the same time, process 400 may preferentially process code orders over non-code orders. In other words, code orders will be processed against the CLOB before non-code orders.

Although illustrated in FIG. 1 as a single component, ETV 110 and end user device 140 may each include a plurality of individual components (e.g., computer devices) each programmed with at least some of the functions described herein. In this manner, some components of ETV 110 and/or end user device 140 may perform some functions while other components may perform other functions, as would be appreciated.

The one or more processors 212 may each include one or more physical processors that are programmed by computer program instructions. The various instructions described herein are exemplary only. Other configurations and numbers of instructions may be used, so long as the processor(s) 212 are programmed to perform the functions described herein. Furthermore, it should be appreciated that although the various instructions are illustrated in the figures as being co-located within a single processing unit, in implementations in which processor(s) 212 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 212 may be programmed by one or more additional instructions that may perform some or all of the functionality attributed herein to one of the instructions.

The various instructions described herein may be stored in a storage device 214, which may comprise random access memory (RAM), read only memory (ROM), and/or other memory. The storage device may store the computer program instructions (e.g., the aforementioned instructions) to be executed by processor 212 as well as data that may be manipulated by processor 212. The storage device may comprise floppy disks, hard disks, optical disks, tapes, or other storage media for storing computer-executable instructions and/or data.

Code repository 122 may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in the figures are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail above) are exemplary by nature and, as such, should not be viewed as limiting. As used herein, the term “exemplary” is meant to denote “example of.”

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of processing code orders that specify orders to be processed on an electronic trading venue (ETV) based on computer code referenced by or included with the code orders, the method being implemented by a computer system having one or more physical processors programmed with computer program instructions that, when executed by the one or more physical processors, program the computer system to perform the method, the method comprising:
receiving, by the computer system, a code order from a market participant via a network;
obtaining, by the computer system, based on the code order, computer code that includes logic configured to define a behavior of an order to be processed on the ETV;
executing, by the computer system, the computer code; and
processing, by the computer system, the order based on executing the computer code.

2. The method of claim 1, the method further comprising:
obtaining, by the computer system, a bid or offer state of an instrument to which the order relates, wherein the bid or offer state is indicative of bids and/or offers with respect to the instrument, and wherein processing the order comprises:
using, by the computer system, the bid or offer state as an input to the computer code; and
altering, by the computer system, the behavior of the order based on the input.

3. The method of claim 2, wherein altering the behavior of the order comprises canceling, by the computer system, the order based on the bid or offer state.

4. The method of claim 2, wherein altering the behavior of the order comprises repricing, by the computer system, a buy price or a sell price of the order based on the bid or offer state.

5. The method of claim 2, wherein altering the behavior of the order comprises adjusting, by the computer system, a quantity of the instrument to be purchased or sold based on the bid or offer state.

6. The method of claim 1, wherein the code order comprises source code, and wherein obtaining the computer code comprises:
obtaining, by the computer system, the source code from the code order; and
compiling, by the computer system, the source code to generate the computer code.

7. The method of claim 1, wherein the code order comprises source code, and wherein obtaining the computer code comprises:
obtaining, by the computer system, the source code from the code order; and
interpreting, by the computer system, the source code to generate the computer code.

8. The method of claim 1, wherein the code order comprises a reference to the computer code, and wherein obtaining the computer code comprises:
obtaining, by the computer system, the reference from the code order; and
obtaining, by the computer system, based on the reference, the computer code from a memory device configured to store the computer code in association with the reference.

9. The method of claim 1, wherein the code order comprises a reference to source code, and wherein obtaining the computer code comprises:
obtaining, by the computer system, the reference from the code order;
obtaining, by the computer system, based on the reference, the source code from a memory device configured to store the source code in association with the reference; and
compiling, by the computer system, the source code to generate the computer code.

10. The method of claim 1, the method further comprising:
receiving, by the computer system, source code corresponding to the computer code; and
storing, by the computer system, in a memory device, the source code in association with a reference for later retrieval using the reference.

11. The method of claim 1, the method further comprising:
receiving, by the computer system, source code corresponding to the computer code;
compiling, by the computer system, the source code to generate the computer code; and
storing, by the computer system, in a memory device, the computer code in association with a reference for later retrieval using the reference.

12. The method of claim 1, the method further comprising:
receiving, by the computer system, the computer code; and
storing, by the computer system, in a memory device, the computer code in association with a reference for later retrieval using the reference.

13. The method of claim 1, wherein processing the order comprises evaluating one or more parameters of the order against a bid or offer state of an instrument to which the order relates to determine whether or not to execute the order, wherein the bid or offer state is indicative of bids and/or offers with respect to the instrument, the method further comprising:
determining, by the computer system, at a first time, that a trade associated with the order should not be executed based on the evaluation of the one or more parameters of the order against the bid or offer state;
receiving, by the computer system, via the network, a second order after the first time, wherein the second order relates to the instrument and is received after receipt of the code order; and
evaluating, by the computer system, at a second time after receipt of the second order, the one or more parameters of the order against the bid or offer state prior to processing the second order; and
processing, by the computer system, the second order after evaluating the one or more parameters of the order.

14. The method of claim 13, wherein the order specified by the code order is processed against the bid or offer state, together with at least one other order specified by at least one other code order, prior to processing the second order.

15. The method of claim 1, wherein obtaining the computer code based on the code order comprises:
reading, by the computer system, the code order; and
identifying, by the computer system, based on the reading, a key-value pair that includes either (i) a reference to the computer code, (ii) a reference to source code for the computer code, (iii) the source code, or (iv) the computer code, wherein the computer code is obtained based on the key-value pair.

16. The method of claim 1, the method further comprising:
receiving, by the computer system, a second order;
parsing, by the computer system, a key-value pair included in the second order;
determining, by the computer system, whether the second order includes either (i) a reference to the computer code, (ii) a reference to source code for the computer code, (iii) the source code, or (iv) the computer code,
responsive to a determination that the second order comprises either (i) a reference to the computer code, (ii) a reference to source code for the computer code, (iii) the source code, or (iv) the computer code:
obtaining, by the computer system, based on the second order, the computer code;
executing, by the computer system, the computer code; and
processing, by the computer system, the second order based on executing the computer code; and
responsive to a determination that the order does not comprise either (i) a reference to the computer code, (ii) a reference to source code for the computer code, (iii) the source code, or (iv) the computer code:
processing, by the computer system, the second order.

17. A system of processing code orders that specify orders to be processed on an electronic trading venue (ETV) based on computer code referenced by or included with the code orders, the system comprising:
a computer system having one or more physical processors programmed with computer program instructions that, when executed by the one or more physical processors, program the computer system to:
receive a code order from a market participant via a network;
obtain, based on the code order, computer code that includes logic configured to define a behavior of an order to be processed on the ETV;
execute the computer code; and
process the order based on executing the computer code.

18. The system of claim 17, wherein the computer system is further programmed to:
obtain a bid or offer state of an instrument to which the order relates, wherein the bid or offer state is indicative of bids and/or offers with respect to the instrument, and wherein processing the order comprises:
use the bid or offer state as an input to the computer code; and
alter the behavior of the order based on the input.

19. The system of claim 18, wherein to alter the behavior of the order, the computer system is programmed to cancel the order based on the bid or offer state.

20. The system of claim 18, wherein to alter the behavior of the order, the computer system is programmed to reprice a buy price or a sell price of the order based on the bid or offer state.

21. The system of claim 18, wherein to alter the behavior of the order, the computer system is programmed to adjust a quantity of the instrument to be purchased or sold based on the bid or offer state.

22. The system of claim 17, wherein the code order comprises source code, and wherein to obtain the computer code, the computer system is programmed to:
obtain the source code from the code order; and
compile the source code to generate the computer code.

23. The system of claim 17, wherein the code order comprises source code, and wherein to obtain the computer code, the computer system is programmed to:
obtain the source code from the code order; and
interpret the source code to generate the computer code.

24. The system of claim 17, wherein the code order comprises a reference to the computer code, and wherein to obtain the computer code, the computer system is programmed to:
obtain the reference from the code order; and
obtain, based on the reference, the computer code from a memory device configured to store the computer code in association with the reference.

25. The system of claim 17, wherein the code order comprises a reference to source code, and wherein to obtain the computer code, the computer system is programmed to:
obtain the reference from the code order;
obtain, based on the reference, the source code from a memory device configured to store the source code in association with the reference; and
compile the source code to generate the computer code.

26. The system of claim 17, wherein the computer system is further programmed to:
receive source code corresponding to the computer code; and
store, in a memory device, the source code in association with a reference for later retrieval using the reference.

27. The system of claim 17, wherein the computer system is further programmed to:
receive, source code corresponding to the computer code;
compile the source code to generate the computer code; and
store, in a memory device, the computer code in association with a reference for later retrieval using the reference.

28. The system of claim 17, wherein the computer system is further programmed to:
receive the computer code; and
store, in a memory device, the computer code in association with a reference for later retrieval using the reference.

29. The system of claim 17, wherein to process the order, the computer system is further programmed to:
evaluate one or more parameters of the order against a bid or offer state of an instrument to which the order relates to determine whether or not to execute the order, wherein the bid or offer state is indicative of bids and/or offers with respect to the instrument:
determine, at a first time, that a trade associated with the order should not be executed based on the evaluation of the one or more parameters of the order against the bid or offer state;
receive, via the network, a second order after the first time, wherein the second order relates to the instrument and is received after receipt of the code order; and
evaluate, at a second time after receipt of the second order, the one or more parameters of the order against the bid or offer state prior to processing the second order; and
process the second order after evaluating the one or more parameters of the order.

30. The system of claim 29, wherein the order specified by the code order is processed against the bid or offer state, together with at least one other order specified by at least one other code order, prior to processing the second order.

31. The system of claim 17, wherein to obtain the computer code based on the code order, the computer system is programmed to:
read the code order; and
identify, based on the reading, a key-value pair that includes either (i) a reference to the computer code, (ii) a reference to source code for the computer code, (iii) the source code, or (iv) the computer code, wherein the computer code is obtained based on the key-value pair.

32. The system of claim 17, wherein the computer system is further programmed to:
receive a second order;
parse a key-value pair included in the second order;
determine whether the second order includes either (i) a reference to the computer code, (ii) a reference to source code for the computer code, (iii) the source code, or (iv) the computer code,
responsive to a determination that the second order comprises either (i) a reference to the computer code, (ii) a reference to source code for the computer code, (iii) the source code, or (iv) the computer code:
obtain, based on the second order, the computer code;
execute the computer code; and
process the second order based on executing the computer code; and
responsive to a determination that the order does not comprise either (i) a reference to the computer code, (ii) a reference to source code for the computer code, (iii) the source code, or (iv) the computer code:
process the second order.
